(19) United States
(12) Patent Application Publication
(10) Pub. No.: US 2026/0366661 A1
(43) Pub. Date: Nov. 19, 2026

(54) FLUID COUPLING ASSEMBLY

(71) Applicant: Auras Technology Co., Ltd., New Taipei City (TW)

(72) Inventors: Chien-Yu CHEN, New Taipei City (TW); Tian-Li YE, New Taipei City (TW); Yi-Le CHENG, New Taipei City (TW); Xin-Yu YANG, New Taipei City (TW)

(21) Appl. No.: 19/410,404

(22) Filed: Dec. 5, 2025

Related U.S. Application Data
(60) Provisional application No. 63/808,059, filed on May 19, 2025.

(51) Int. Cl. F16L 37/10; F16L 37/38

(52) U.S. Cl. CPC F16L 37/10; F16L 37/38

(57) ABSTRACT

A fluid coupling assembly includes a female body, a male body, a valve ring sleeve, and a release jig sleeved above the valve ring sleeve to abut the upper edge of the valve ring sleeve. The female body has a connecting channel, two positioning grooves, two positioning rods, and a gasket ring. The positioning grooves are communicated between the outer wall of the female body and the inner wall of the connecting channel. The positioning rods are slidably connected in the positioning grooves. The gasket ring is sleeved on the female body and located below the positioning rods. The male body has a connecting portion in the connecting channel and has a male groove. The positioning rods are in the male groove when exposed on the connecting channel. The valve ring sleeve is sleeved on the female body and abutted against the positioning rods.

### RELATED APPLICATIONS

This application claims priority to US Provisional Application Serial Number 63/808,059, filed May 19, 2025, which is herein incorporated by reference in its entirety.

### BACKGROUND

### Field of Invention

The present disclosure relates to a fluid coupling assembly and, more particularly, to a fluid coupling assembly with a release jig.

### Description of Related Art

Fluid quick connecting assemblies are connection elements specifically designed for hydraulic, pneumatic, or other fluid systems, enabling rapid connection and disconnection of pipelines without tools. The main structure of a fluid quick connecting assembly typically includes a male connector and a female connector, which are ensured the sealing and fixation thereof with specially designed mechanism. This design significantly reduces installation and maintenance time and lowers the risk of fluid leakage caused by disassembly and assembly.

However, the fluid quick connecting assembly in connecting and disconnecting operations without tools still requires special skill and strength from the user. Thus, to improve the efficiency of the fluid quick connecting assembly in connecting and disconnecting operations, more innovative improvements are needed.

### SUMMARY

One objective of the present disclosure is to provide a fluid coupling assembly to solve the difficulties mentioned in the related art.

An embodiment of the present disclosure is to provide a fluid coupling assembly. The fluid coupling assembly includes a female body, a male body, a valve ring sleeve, and a release jig. The female body has a connecting channel, two positioning grooves, two positioning rods and a gasket ring. The two positioning grooves are communicated between an outer wall of the female body and an inner wall of the connecting channel. The two positioning rods are respectively slidably connected in the two positioning grooves. The gasket ring is sleeved on the outer wall of the female body and located below the two positioning rods. The male body has a connecting portion received within in the connecting channel and provided with a male groove, and the two positioning rods are respectively located in the male groove when exposed on the inner wall of the connecting channel. The valve ring sleeve sleeved on the female body and abutted against the two positioning rods. The release jig is sleeved above the valve ring sleeve and abutted against the upper edge of the valve ring sleeve.

In one embodiment of the present disclosure, the male body is provided with an L-shaped fluid channel or a straight fluid channel.

In one embodiment of the present disclosure, the release jig is provided with a baffle plate that abuts against the upper edge of the valve ring sleeve.

In one embodiment of the present disclosure, an angle defined between an extending direction of the two positioning grooves and an axial direction of the female body is an acute angle.

In one embodiment of the present disclosure, the female body further comprises an annular protrusion portion, and a spring surrounding the outer wall of the female body and located between the gasket ring and the annular protrusion portion.

In one embodiment of the present disclosure, the female body further comprises a threaded connection portion, and the annular protrusion portion is located between the spring and the threaded connection portion.

In one embodiment of the present disclosure, the release jig is provided with a baffle plate abutting against the upper edge of the valve ring sleeve, and a semicircular ring abutted against a side wall of the valve ring sleeve.

In one embodiment of the present disclosure, the baffle plate comprises a semi-circular groove or a two-thirds circular groove.

In one embodiment of the present disclosure, the valve ring sleeve is provided with a flange ring abutting against the two positioning rods.

In one embodiment of the present disclosure, when the release jig is pressed down to move the baffle plate downwardly, the baffle plate presses down against the upper edge of the valve ring sleeve, the flange ring of the valve ring sleeve presses the two positioning rods down to move the gasket ring downwardly, such that the two positioning rods are disengaged from the male groove.

Thus, through the above architecture, the fluid coupling assembly of the disclosure allows a user to have the male body and female body being disengaged from an interlocked state by exerting single handed-force in accordance with the interconnection of the release jig, the valve ring sleeve, the positioning grooves, the positioning rods and the gasket ring of the fluid coupling assembly.

The above is only used for describing the problem to be solved, the technical means to solve the problem, and the effect thereof and the like in the present disclosure, and the specific details of the present disclosure will be described in detail in the following implementations and related figures.

### BRIEF DESCRIPTION OF THE DRAWINGS

FIG. 1 is a side view of a fluid coupling assembly according to a first embodiment of the present disclosure.

FIG. 2 is a perspective view of a release jig of the fluid coupling assembly in FIG. 1.

FIG. 3 is a side view of the fluid coupling assembly in FIG. 1 from being removed the release jig and the valve ring sleeve.

FIG. 4 is a cross-sectional view of the fluid coupling assembly viewed along a section A-A in FIG. 1 in a first interlocked state.

FIG. 5 is a cross-sectional view of the fluid coupling assembly viewed along a section A-A in FIG. 1 in a second interlocked state.

FIG. 6 is a cross-sectional view of the fluid coupling assembly viewed along a section A-A in FIG. 1 in an unlocked state.

FIG. 7 is a side view of the fluid coupling assembly in FIG. 1, from being removed the release jig and the valve ring sleeve in the unlocked state.

FIG. 8 is a side view of the fluid coupling assembly according to a second embodiment of the present disclosure.

FIG. 9 is a perspective view of a release jig of the fluid coupling assembly of FIG. 8.

FIG. 10 is a side view of the fluid coupling assembly in FIG. 8 from being removed the release jig and the valve ring sleeve.

FIG. 11 is a cross-sectional view of the fluid coupling assembly in a first interlocked state viewed along a section B-B in FIG. 8.

FIG. 12 is a cross-sectional view of the fluid coupling assembly in a second interlocked state viewed along a section B-B in FIG. 8.

FIG. 13 is a cross-sectional view of the fluid coupling assembly in an unlocked state viewed along a section B-B in FIG. 8.

FIG. 14 is a side view of the fluid coupling assembly of FIG. 8 with the release jig and valve ring removed in the unlocked state.

FIG. 15 is a cross-sectional view of the fluid coupling assembly of the first embodiment of the present disclosure viewed along the positioning rod.

### DETAILED DESCRIPTION

To render the description of the invention more detailed and complete, reference is made to the drawings and the embodiments described below, wherein identical numbers represent identical or analogous elements. Conversely, well-known components and operations are not detailed in the embodiments, so as not to unnecessarily limit the scope of the invention.

In the embodiments and the claims of the present application, unless otherwise expressly specified, the articles “a” and “the” are to be construed as covering both the singular and the plural forms.

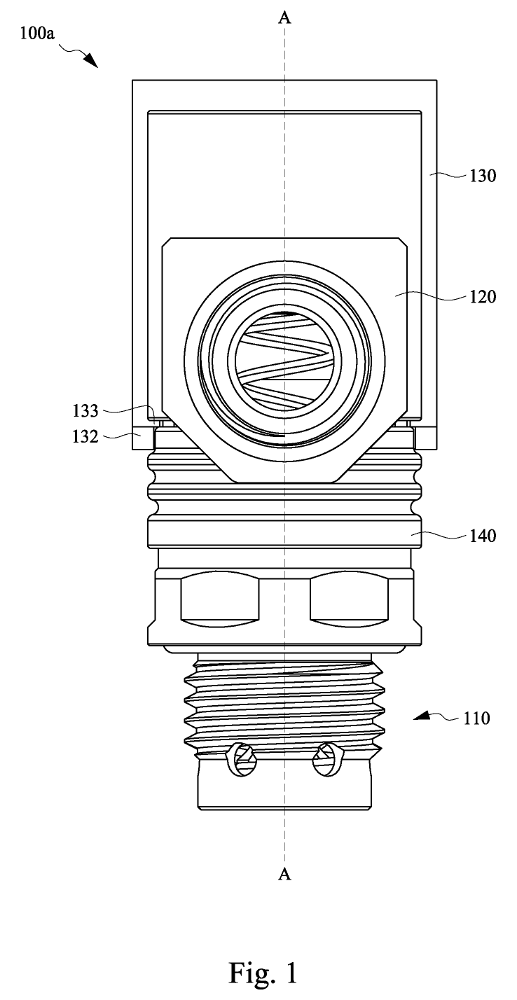

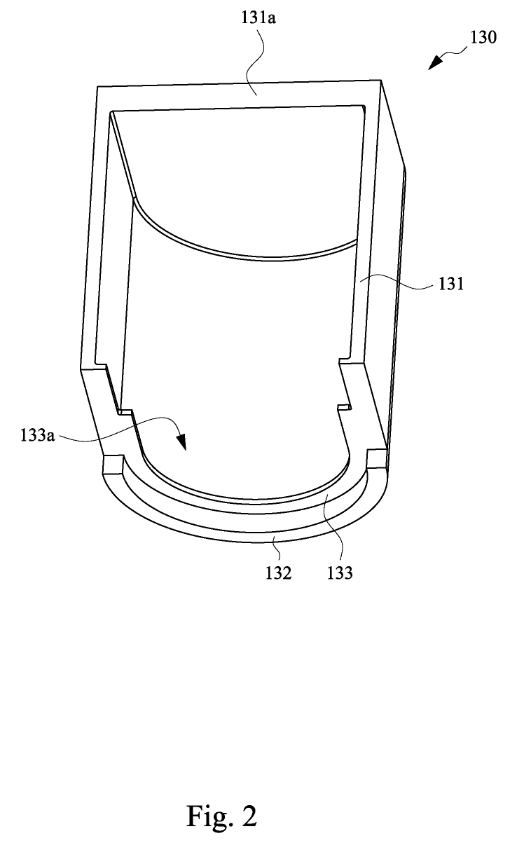

Reference is made to FIGS. 1 and 2 in which FIG. 1 is a side view of a fluid coupling assembly 100a according to a first embodiment of the present disclosure, and FIG. 2 is a perspective view of a release jig 130 of the fluid coupling assembly 100a in FIG. 1. The release jig 130 is used to sleeved above the valve ring sleeve 140 and abut against the upper edge of the valve ring sleeve 140 of the fluid coupling assembly 100a, thereby more effectively controlling the fluid coupling assembly 100a to quickly unlock from an interlocked state.

The fluid coupling assembly 100a includes a female body 110, a male body 120 and a valve ring sleeve 140. The valve ring sleeve 140 is sleeved on the female body 110 and used to control the fluid coupling assembly 100a to quickly unlock from the interlocked state. The release jig 130 is sleeved above the valve ring sleeve 140 so that a user can quickly have the male body 120 and female body 110 being disengaged from the interlocked state by exerting single handed-force.

The release jig 130 includes a cover 131, a semicircular ring 132 and a baffle plate 133. The baffle plate 133 extends inward from the bottom end of the cover 131 to form a groove 133a. The semicircular ring 132 is formed by further extending downward from the bottom end of the cover 131. The baffle plate 133 abuts against the upper edge of the valve ring sleeve 140, and the semicircular ring 132 abuts against a side wall of the valve ring sleeve 140.

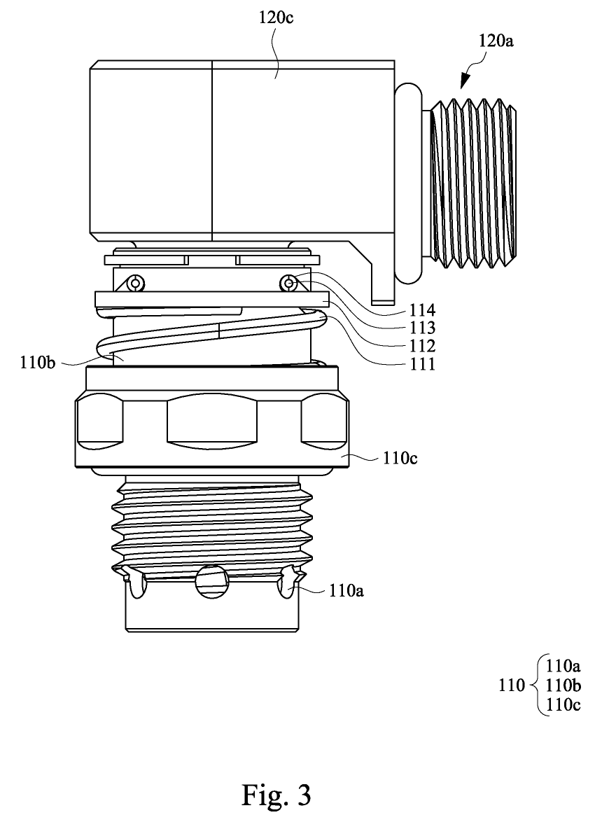

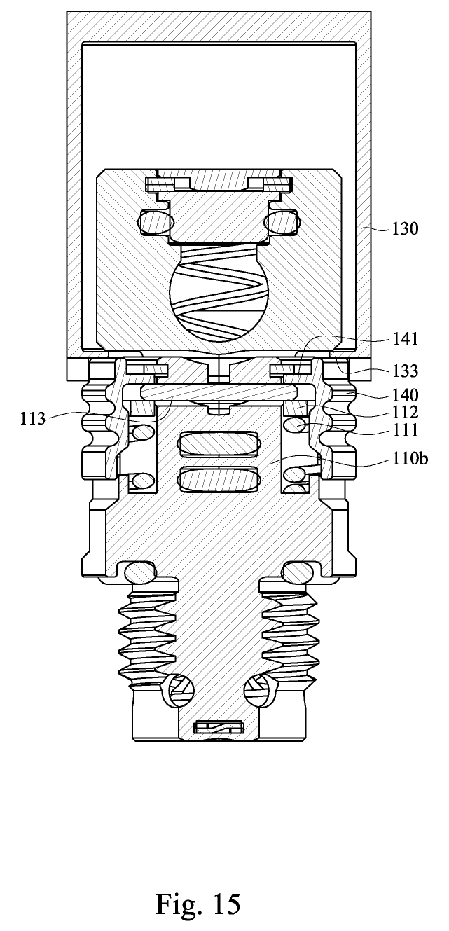

FIG. 3 is a side view of the fluid coupling assembly 100a in FIG. 1 from being removed the release jig 130 and the valve ring sleeve 140. The female body 110 includes a threaded connection portion 110a, a coupling portion 110b, and an annular protrusion portion 110c. The annular protrusion portion 110c is located between the threaded connection portion 110a and the coupling portion 110b. The coupling portion 110b is provided with two positioning grooves 114 and two positioning rods 113. The two positioning rods 113 are respectively slidably connected within the two positioning grooves 114, and each of the two positioning rods 113 is slidably received in one of the two positioning grooves 114. Please also refer to FIG. 15, an inner side of the valve ring sleeve 140 is provided with a flange ring 141 extending towards the coupling portion 110b. The flange ring 141 is located above the two positioning rods 113 and abuts against the two positioning rods 113. The female body 110 further includes a spring 111 and a gasket ring 112. The spring 111 surrounds the outer wall of the coupling portion 110b of the female body 110, and located between the gasket ring 112 and the annular protrusion portion 110c. The spring 111 and the gasket ring 112 are both located between the valve ring sleeve 140 and the coupling portion 110b. The pushing force provided by the spring 111 causes the gasket ring 112 to push the two positioning rods 113 upward to confine the two positioning rods 113 within the two positioning grooves 114.

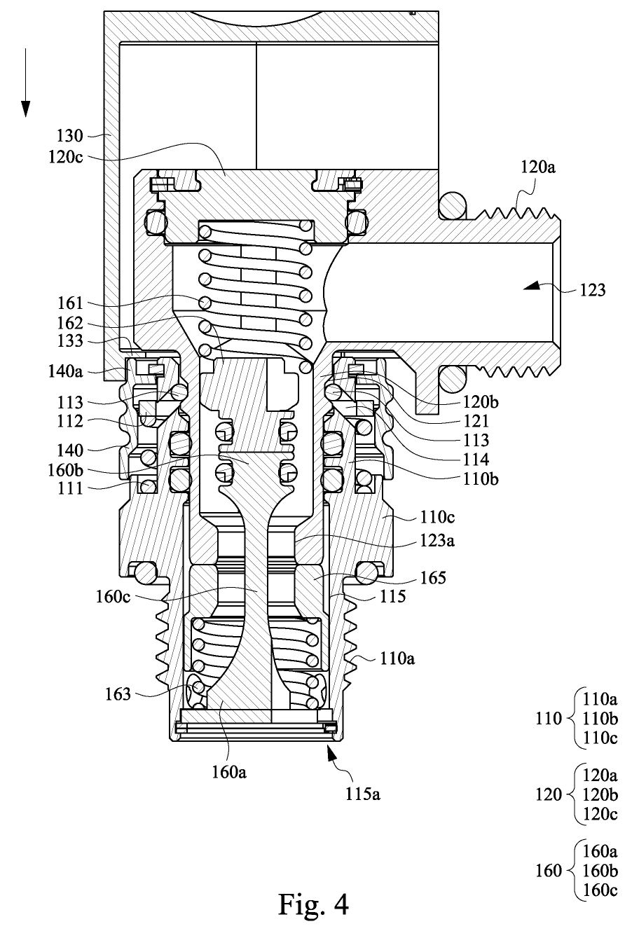

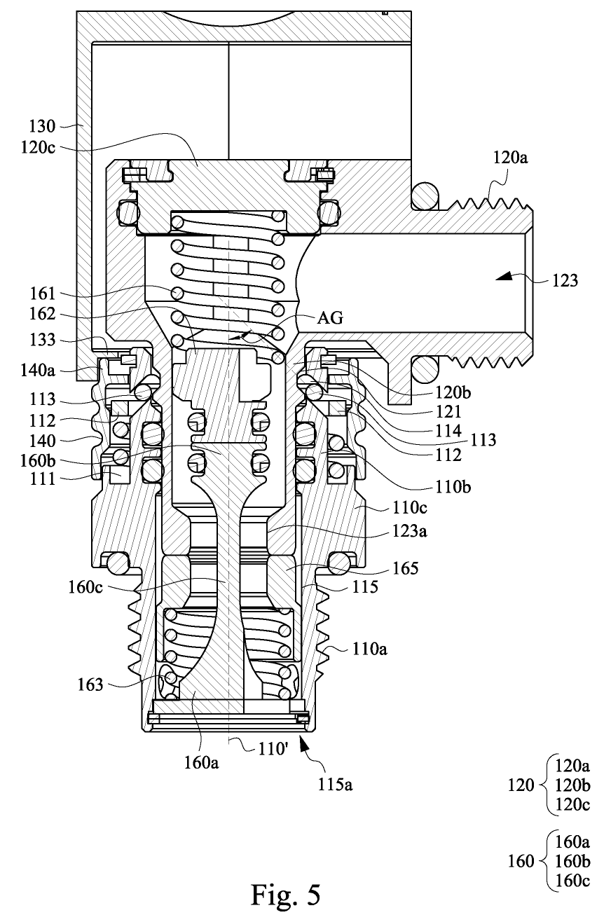

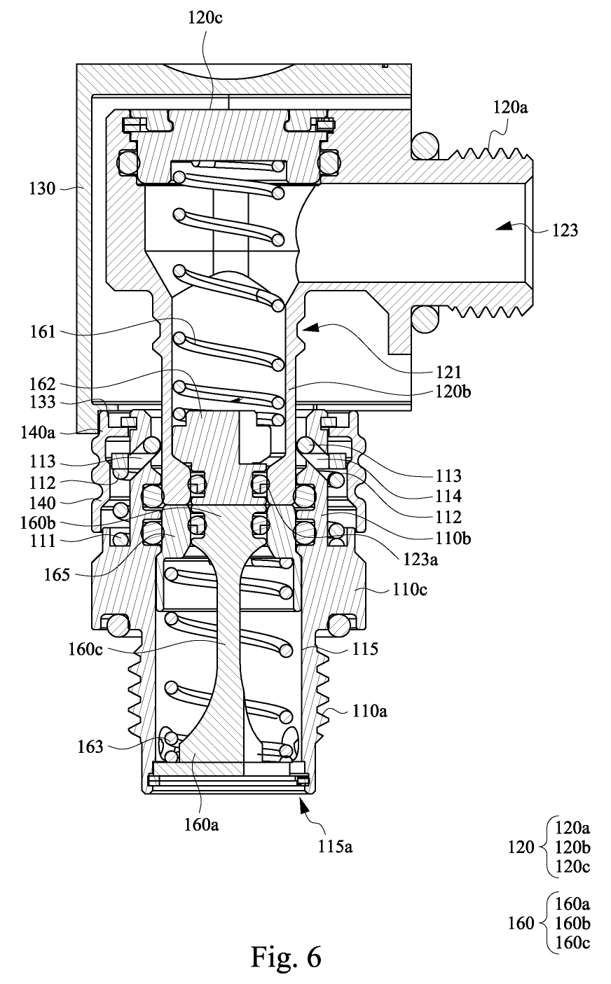

Please refer to FIGS. 4-6 simultaneously, and FIG. 4 is a cross-sectional view of the fluid coupling assembly 100a viewed along a section A-A in FIG. 1 in a first interlocked state, FIG. 5 is a cross-sectional view of the fluid coupling assembly 100a viewed along a section A-A in FIG. 1 in a second interlocked state, and FIG. 6 is a cross-sectional view of the fluid coupling assembly 100a viewed along a section A-A in FIG. 1 in an unlocked state. The interlocking state of the fluid coupling assembly 100a means the interlocking state of the connecting portion 120b of the male body 120 and the coupling portion 110b of the female body 110.

The male body 120 includes a threaded connection portion 120a, a connecting portion 120b, and a turning portion 120c. The turning portion 120c is located between the threaded connection portion 120a and the connecting portion 120b. The connecting portion 120b of the male body 120 is inserted into and received within a connecting channel 115 of the female body 110.

The connecting portion 120b of the male body 120 is formed with a male groove 121. The two positioning grooves 114 are communicated between the outer wall of the coupling portion 110b and the inner wall of the connecting channel 115. When the connecting portion 120b of the male body 120 and the coupling portion 110b of the female body 110 are mutually engaged in a first interlocked state (refer to FIG. 4), the two positioning rods 113 are respectively located in the male groove 121 when exposed on the inner wall of the connecting channel 115 thereby restricting the relative movement of the connecting portion 120b of the male body 120 and the coupling portion 110b of the female body 110. Refer to FIG. 5, an angle AG defined between an extending direction of the two positioning grooves 114 and an axial direction 110’ of the female body 110 is an acute angle. In other words, the extension direction of the two positioning grooves 114 allows the two positioning rods 113 to slide down by gravity (when the gasket ring 112 moves down and does not push the two positioning rods 113).

Please refer to FIG. 5 and 15 simultaneously. When the release jig 130 is pressed down with exerting force in, for example, a direction of the arrow in FIG. 4 to render the connecting portion 120b of the male body 120 and the coupling portion 110b of the female body 110 mutually engaged in a second interlocked state (also known as a semi-unlocked state), the release jig 130 abuts against an upper edge of the valve ring sleeve 140 so as to cause the valve ring sleeve 140 to slide downwardly. At this moment, the baffle plate 133 of the release jig 130 presses the valve ring sleeve 140 down by the upper edge 140a of the valve ring sleeve 140, thereby causing the flange ring 141 of the valve ring sleeve 140 to abut against and press down the two positioning rods 113, and move the gasket ring 112 downwardly. Accordingly, the two positioning rods 113 can be slid down by gravity, disengaged from the male groove 121 and positioned at a middle part of the two positioning grooves 114, thereby allowing the connecting portion 120b of the male body 120 and the coupling portion 110b of the female body 110 are slid relative to each other for unlocking.

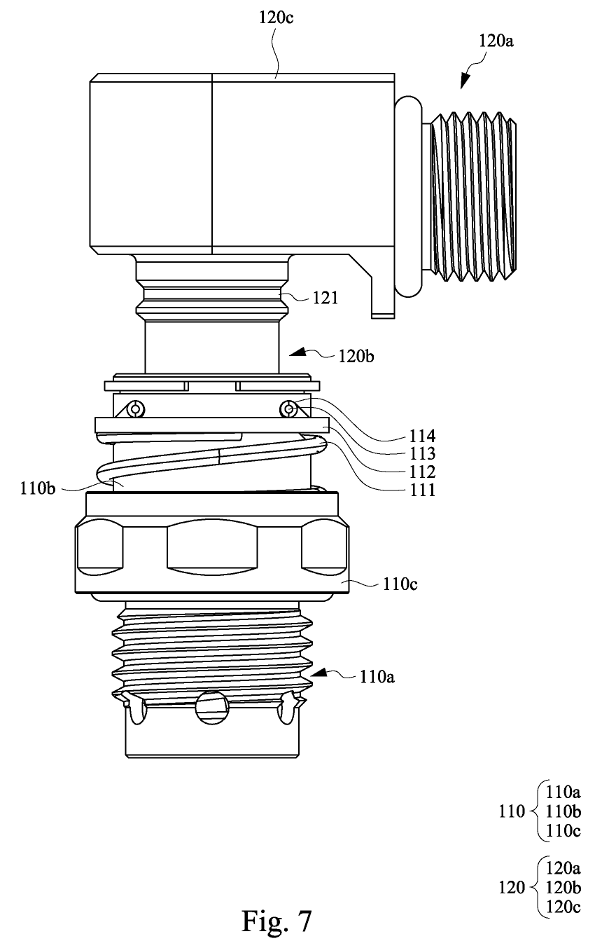

Next, referring to FIGS. 6 and 7, due to the elastic force of springs 161 and 163, the connecting portion 120b of the male body 120 is partially disengaged from the coupling portion 110b of the female body 110 to be in an unlocked state. Accordingly, the male groove 121 of the connecting portion 120b can be disengaged and exposed from the coupling portion 110b of the female body 110.

The female body 110 also includes a valve body 160. The valve body 160 includes a bottom end 160a, a head portion 160b, and a stem portion 160c. The stem portion 160c has an outer diameter smaller than the bottom end 160a and the head portion 160b, and the stem portion 160c is arranged between the bottom end 160a and the head portion 160b, and connected to the bottom end 160a and the head portion 160b, respectively. The bottom end 160a of the valve body 160 is connected to a bottom opening 115a of the connecting channel 115 of the female body 110. When the female body 110 and the male body 120 are mutually engaged in the first interlocked state or the second interlocked state, the head portion 160b of the valve body 160 is slidably connected to the fluid channel 123 in the connecting portion 120b of the male body 120.

The spring 161 is located within the fluid channel 123 of the male body 120, arranged between the turning portion 120c and the valve head 162 and connected to the turning portion 120c and the valve head 162, respectively. The spring 163 is arranged between the bottom end 160a of the valve body 160 and the valve sleeve 165 of the female body 110 and connected to the bottom end 160a of the valve body 160 and the valve sleeve 165 of the female body 110, respectively.

Refer to FIGS. 4 and 5, when the connecting portion 120b of the male body 120 and the coupling portion 110b of the female body 110 are mutually engaged in the first interlocked state or the second interlocked state, the head portion 160b and the stem portion 160c of the valve body 160 are located within the fluid channel 123 of the male body 120 so that fluid can freely flow within the fluid channel 123. Specifically, the fluid channel 123 has a flow limiting section 123a therein, and the outer diameter of the head portion 160b of the valve body 160 is smaller than the inner diameter of the flow limiting section 123a in the fluid channel 123, so that the fluid channel 123 allows fluid to be freely flowed therein.

Refer to FIGS. 6 and 7, when the connecting portion 120b of the male body 120 and the coupling portion 110b of the female body 110 are mutually disengaged in the unlocked state, the fluids in the connecting channel 115 of the female body 110 and the fluid channel 123 of the male body 120 cannot be freely communicated to each other.

Specifically, the outer surrounding part of the head portion 160b of the valve body 160 in the female body 110 is tightly sealed with the inner surrounding wall of the valve sleeve 165, and the outer surrounding part of the valve sleeve 165 is tightly sealed to the inner surrounding wall of the coupling portion 110b, so that the connecting channel 115 does not allow fluid to be freely flowed therein. At this moment, the outer surrounding part of the valve head 162 in the male body 120 is tightly sealed with the flow limiting section 123a of the fluid channel 123, so that the fluid channel 123 does not allow fluid to be freely flowed therein.

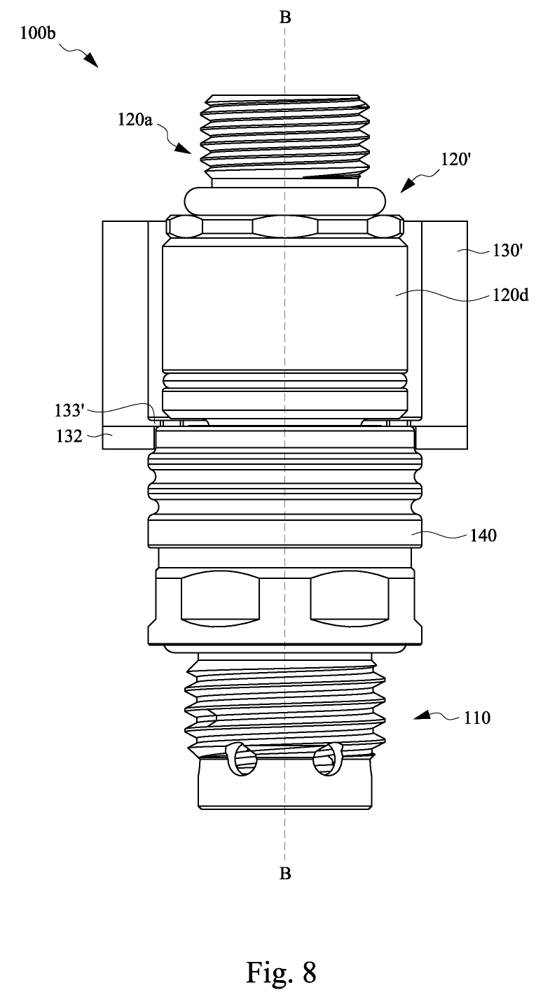

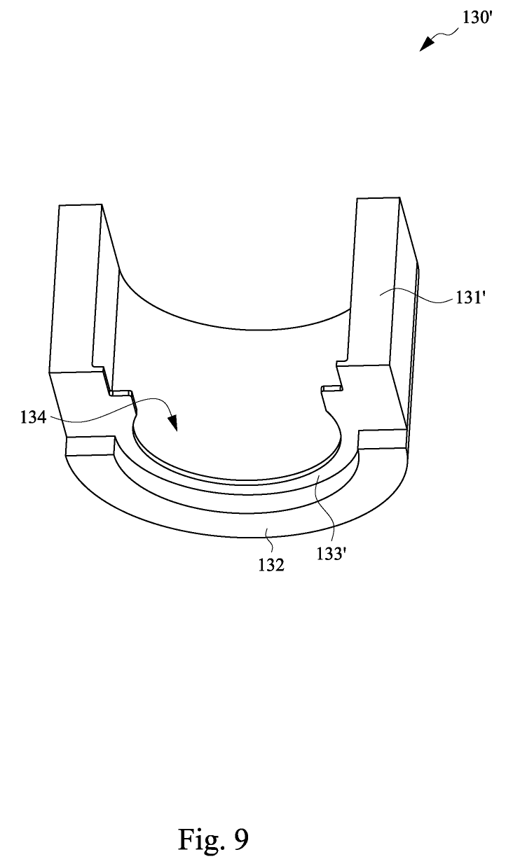

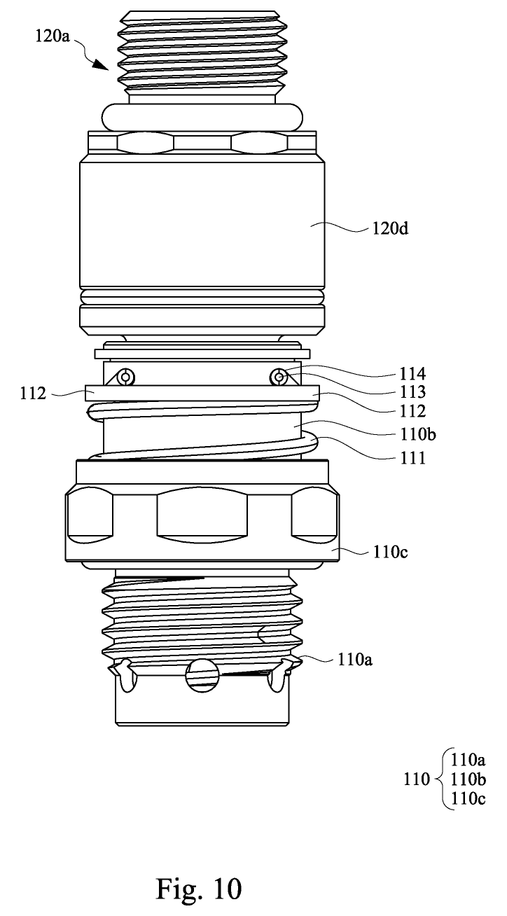

Refer to FIGS. 8-10 simultaneously in which FIG. 8 is a side view of the fluid coupling assembly 100b according to a second embodiment of the present disclosure, FIG. 9 is a perspective view of a release jig 130’ of the fluid coupling assembly of FIGS. 8 and 10 is a side view of the fluid coupling assembly in FIG. 8 from being removed the release jig and the valve ring sleeve. The main differences between the fluid coupling assembly 100b of this embodiment and the fluid coupling assembly 100a of the first embodiment are the male body 120' and the release jig 130' in the second embodiment which are modified respectively.

The release jig 130' includes a cover 131', a semicircular ring 132, and a baffle plate 133'. The baffle plate 133’ extends inward from the bottom end of the cover 131’ to form a groove 134. The semicircular ring 132 is formed by further extending downward from the bottom end of the cover 131’. The baffle plate 133' abuts against the upper edge 140a of the valve ring sleeve 140, and the semicircular ring 132 abuts against the side wall of the valve ring sleeve 140.

The release jig 130' is different from the release jig 130 in that: the cover 131' is not proved with a top wall 131a of the cover 131; the groove 134 includes a two-thirds circular groove, and the groove 133a includes a semi-circular groove. The cover 131' that is designed without a top wall is to match the shape of the male body 120', and also provided with elasticity able to be recovered from deformation so that the groove 134 of the baffle plate 133’ can be sleeved on the male body 120'. Although the structure of the baffle plate 133’ is slightly different from that of the baffle plate 133, the actuation relationships among the baffle plate 133’, the valve ring sleeve 140, the two positioning rods 113 and the gasket ring 112 are the same as that in the first embodiment, so it will not be described again.

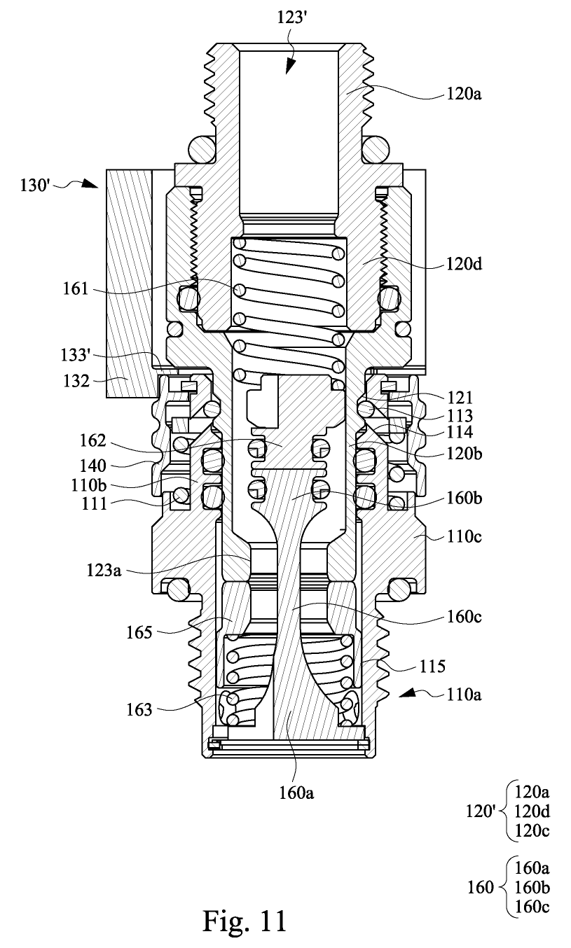

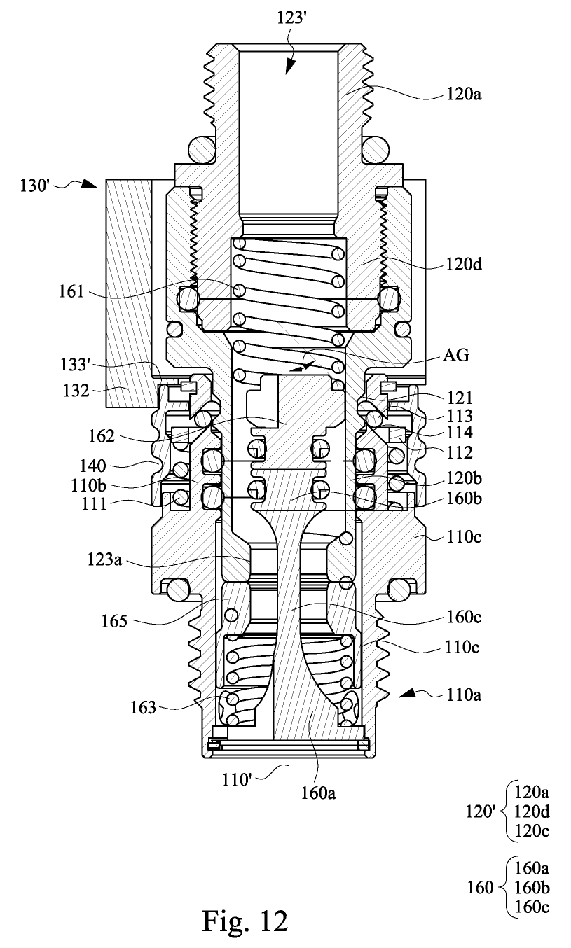

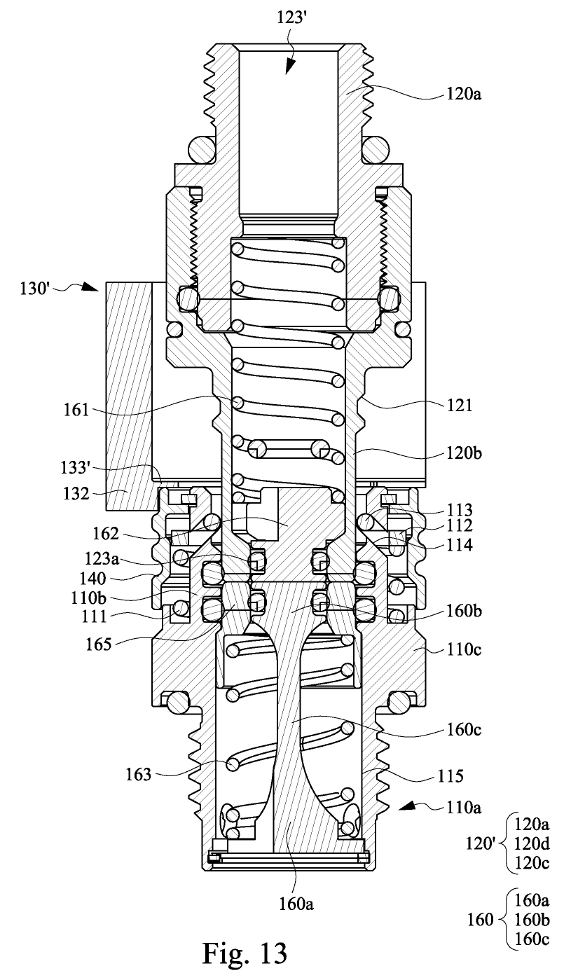

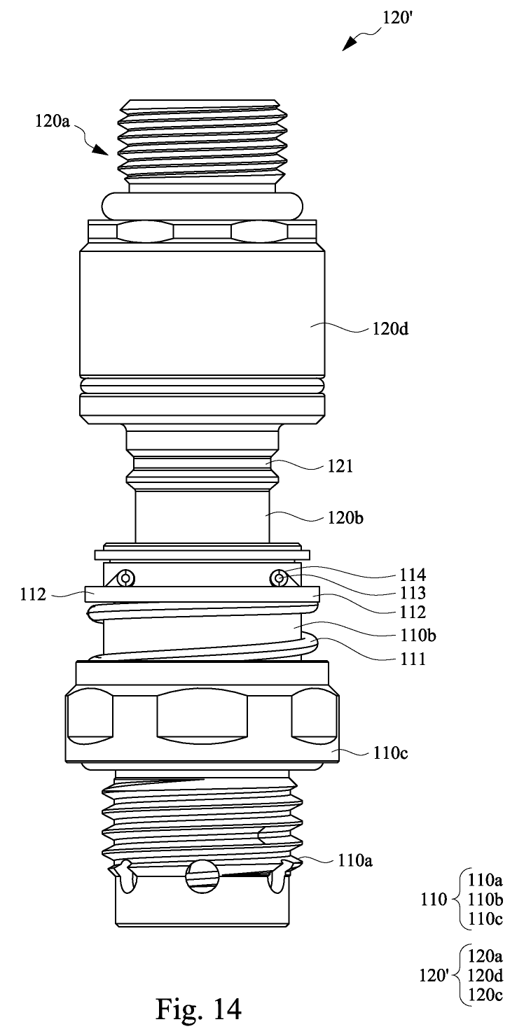

Refer to FIGS. 11-14 simultaneously in which FIG. 11 is a cross-sectional view of the fluid coupling assembly 100b in a first interlocked state viewed along a section B-B in FIGS. 8, 12 is a cross-sectional view of the fluid coupling assembly 100b in a second interlocked state viewed along a section B-B in FIGS. 8, 13 is a cross-sectional view of the fluid coupling assembly in an unlocked state viewed along a section B-B in FIGS. 8, and 14 is a side view of the fluid coupling assembly of FIG. 8 with the release jig and the valve ring removed in the unlocked state.

The male body 120' includes a threaded connection portion 120a, a connecting portion 120b and an annular protrusion portion 120d. The annular protrusion portion 120d is located between the threaded connection portion 120a and the connecting portion 120b. The male body 120' is formed with a straight fluid channel 123’ therein. The connecting portion 120b of the male body 120' is inserted into and received within the connecting channel 115 of the female body 110.

The different between the male body 120' and the male body 120 is that the male body 120' is formed with a straight fluid channel 123' therein, and the male body 120 is formed with an L-shaped fluid channel 123 therein. The release jig 130' is also modified to differ from the release jig 130 due to the structural difference of the male body 120'.

The operation of the male body 120' and female body 110 in the interlocked and unlocked states of the fluid coupling assembly 100b is substantially the same as that of the fluid coupling assembly 100a described above, and will not be described again.

Thus, through the above architecture, the fluid coupling assembly of the disclosure allows a user to have the male body and female body being disengaged from an interlocked state by exerting single handed-force in accordance with the interconnection of the release jig, the valve ring sleeve, the positioning grooves, the positioning rods and the gasket ring of the fluid coupling assembly.

Although the present disclosure has been disclosed with the embodiments above, it is not intended to limit the present disclosure. Any person skilled in the art can make various changes and modifications without departing from the spirit and scope of the present disclosure. Therefore, the scope of protection of the present invention shall be determined by the appended claims.

What is claimed is:

1. A fluid coupling assembly, comprising:
a female body having a connecting channel, two positioning grooves, two positioning rods and a gasket ring, the two positioning grooves that are communicated between an outer wall of the female body and an inner wall of the connecting channel, the two positioning rods that are respectively slidably connected in the two positioning grooves, the gasket ring that is sleeved on the outer wall of the female body and located below the two positioning rods;
a male body having a connecting portion received within in the connecting channel and provided with a male groove, and the two positioning rods respectively located in the male groove when exposed on the inner wall of the connecting channel;
a valve ring sleeve sleeved on the female body and abutted against the two positioning rods; and
a release jig sleeved above the valve ring sleeve and abutted against an upper edge of the valve ring sleeve.

2. The fluid coupling assembly according to claim 1, wherein the male body is provided with an L-shaped fluid channel or a straight fluid channel.

3. The fluid coupling assembly according to claim 1, wherein the release jig is provided with a baffle plate that abuts against the upper edge of the valve ring sleeve.

4. The fluid coupling assembly according to claim 1, wherein an angle defined between an extending direction of the two positioning grooves and an axial direction of the female body is an acute angle.

5. The fluid coupling assembly according to claim 1, wherein the female body further comprises an annular protrusion portion, and a spring surrounding the outer wall of the female body and located between the gasket ring and the annular protrusion portion.

6. The fluid coupling assembly according to claim 5, wherein the female body further comprises a threaded connection portion, and the annular protrusion portion is located between the spring and the threaded connection portion.

7. The fluid coupling assembly according to claim 1, wherein the release jig is provided with a baffle plate abutting against the upper edge of the valve ring sleeve, and a semicircular ring abutted against a side wall of the valve ring sleeve.

8. The fluid coupling assembly according to claim 7, wherein the baffle plate comprises a semi-circular groove or a two-thirds circular groove.

9. The fluid coupling assembly according to claim 3, wherein the valve ring sleeve is provided with a flange ring abutting against the two positioning rods.

10. The fluid coupling assembly according to claim 9, wherein when the release jig is pressed down to move the baffle plate downwardly, the baffle plate presses down against the upper edge of the valve ring sleeve, the flange ring of the valve ring sleeve presses the two positioning rods down to move the gasket ring downwardly, such that the two positioning rods are disengaged from the male groove.
